(19) United States
(12) Patent Application Publication
(10) Pub. No.: US 2012/0330875 A1
(43) Pub. Date: Dec. 27, 2012

(54) STRUCTURE INDEX

(76) Inventor: Jürgen Angele, Herxheim (DE)

(21) Appl. No.: 13/168,589

(22) Filed: Jun. 24, 2011

(51) Int. Cl. G06N 5/04

(52) U.S. Cl. 706/47

(57) ABSTRACT

The present invention relates to a method for answering a query (60) directed to a knowledge base. The basic idea under-lying the present invention is to define a generic knowledge base with generic representatives (30) and generic rules (140). Generic representatives (30) represent the structure of objects (20) of the knowledge base. This enables generic rules (140), which represent the structure of the rules (50) of the knowledge base, to be applied to the generic representatives (30) without evaluating the corresponding objects (20) in a first step. In a second step, the inferred generic answers (90) (which are generic representatives (30)) can be used to restrict the original query (60) to objects (20) which have an appropriate structure. In a similar way, the generic representatives (30) applied for inference can be used to restrict the rules (50) of the knowledge base to objects (20) which have an appropriate structure.

### FIELD OF THE INVENTION

The present invention relates to a method and a system for answering a query directed to a knowledge base, e.g. a database or an ontology.

### DESCRIPTION OF RELATED ART

A knowledge base is a special kind of database for knowledge management, providing the means for the computerized collection, organization, and retrieval of knowledge. Examples of knowledge bases are data bases, relational databases, ontologies, etc.

An index is a data structure or a function which is applied to determine the position of data records within a data storage medium. Indices are commonly applied to improve the speed of data retrieval operations on databases.

Indices can be implemented using a variety of data structures. Commonly applied index structures which are appropriate for conventional data bases are, for example, balanced trees, B+ trees, hashes, bitmap indices and access support relations.

A common drawback of all indices known from the prior art is the fact that each index is optimised to support queries of a certain kind, whilst other queries are not or not optimally supported. Accordingly, some queries will inevitably cause extensive response times.

Furthermore, the indices known from the prior art directly determine certain areas within the data storage medium based on a query directed to the data base. Rules for deducing additional information, which cannot explicitly be found in the original database, are not supported.

### BRIEF SUMMARY OF THE INVENTION

### Ontologies

In computer science, an ontology designates a data model that represents a domain of knowledge and is used to reason about the objects in that domain and the relations between them.

The ontology preferably comprises a hierarchical structure of the classes. Within the hierarchical structure, the classes of a particular layer of the hierarchical structure are allocated to precisely one class of the higher-level layer. In general, there is only a simple inheritance of characteristics in such a case. In general, the class structure can also be arranged in different ways, for example as acyclic graph in which multiple inheritance can also be permitted.

To the classes, attributes are allocated which can be transmitted within a class structure. Attributes are features of a class. The class “person” can have the attribute “hair color”, for example. To this attribute, different values (called “attribute values”) are allocated for different actual persons (called “instances”), e.g. brown, blond, black, etc. Sometimes in the literature, the classes are called “categories” and the attributes are called “properties”.

The query unit contains an inference machine or inference unit by means of which rules can be evaluated.

The rules are rules of inference. They take premises and return a conclusion. They generally have the form “If p then q”. The rules combine elements of the class structure and/or data.

Classes, attributes, synonyms, relations, in short relations between elements and allocations, in short anything from which the ontology or the class structure is built up are called elements of the class structure.

Generally, the rules are arranged as a declarative system of rules. An important property of a declarative system of rules consists in that the results of an evaluation do not depend on the order of the definition of the rules.

The rules enable, for example, information to be found which has not been described explicitly by the search terms. The inference unit even makes it possible to generate, by combining individual statements, new information which was not explicitly contained in the data but can only be inferred from the data (see section query below).

Not only ontologies but also other knowledge bases make use of declarative systems of rules of inference.

An ontology regularly contains the following elements:
a hierarchical structure of classes, that can be understood by the end user,
attributes associated to the classes and their inheritance,
relations between classes,
a declarative system of logical rules, containing further knowledge,
an inference unit by evaluating the rules for answering queries and for generating new knowledge,
a formal logical basis, e.g. based on description logic, which in turn is based on predicate logic (see e.g. http://en.wikipedia.org/wiki/Description_logic: “Description logics (DL) are a family of knowledge representation languages which can be used to represent the terminological knowledge of an application domain in a structured and formally well-understood way. The name description logic refers, on the one hand, to concept descriptions used to describe a domain and, on the other hand to the logic-based semantics which can be given by a translation into first-order predicate logic. Description logic was designed as an extension to frames and semantic networks, which were not equipped with formal logic-based semantics. Description logic was given its current name in the 1980s. Previous to this it was called (chronologically): terminological systems, and concept languages. Today description logic has become a cornerstone of the Semantic Web for its use in the design of ontologies.”
a semantic for assigning meaning to the classes,
an ontology language to formulate the ontology, e.g. OWL, RDF, F-Logic or F-Logic 2, or ObjectLogic.

Thus, ontologies are logical systems that incorporate semantics. Formal semantics of knowledge-representation systems allow the interpretation of ontology definitions as a set of logical axioms. E.g. it can often be left to the ontology itself to resolve inconsistencies in the data structure. If a change in an ontology results in incompatible restrictions on a slot, it simply means that this class will not have any instances (is “unsatisfiable”). If an ontology language based on Description Logics (DL) is used to represent the ontology, one can e.g. use DL reasoners to re-classify changed concepts based on their new definitions. When using ObjectLogic as language, ObjectLogic reasoners can be used for this purpose.

It should be clear to one skilled in the art, that an ontology has many features and capabilities that a simple data schema, database or relational database is lacking.

### Introduction to F-Logic

The language F-Logic is a useful language for the formulation of queries to ontologies [see e.g., J. Angele, M. Kifer, G. Lausen: Ontologies in F-Logic. In S. Staab, R. Studer, eds.: Handbook on Ontologies. International Handbooks on Information Systems, Springer Verlag, Second Edition, 2009, p. 45]. In order to gain some intuitive understanding of the functionality of F-Logic, the following example might be of use, which maps the relations between well-known biblical persons.

First, we define the ontology, i.e. the classes and their hierarchical structure as well as some facts:

man::person.
woman::person.
person[fatherIs{1:1}*=>man].
person[motherIs{1:1}*=>woman].
abraham:man.
sarah:woman.
isaac:man[fatherIs−>abraham, motherIs−>sarah].
ishmael:man[fatherIs−>abraham, motherIs−>hagar:woman].
jacob:man[fatherIs−>isaac, motherIs−>rebekah:woman].
esau:man[fatherIs−>isaac, motherIs−>rebekah].

Obviously, some classes are defined: “man”, “woman”, and person. E.g., Abraham is a man. The class “person” has the properties “fatherIs” and “motherIs”, which are indicating the parents. E.g., the man Isaac has the father Abraham and the mother Sarah. In this particular case, the properties are object properties.

Although F-Logic is suited for defining the class structure of an ontology, nevertheless, in many cases, the ontology languages RDF or OWL are used for these purposes.

Further, some rules are given, defining the dependencies between the classes:

?X[sonIs−>?Y] :- ?Y:man[fatherIs−>?X].
?X[sonIs−>?Y] :- ?Y:man[motherIs−>?X].
?X[daughterIs−>?Y] :- ?Y:woman[fatherIs−>?X].
?X[daughterIs−>?Y] :- ?Y:woman[motherIs−>?X].

Rules written using F-Logic consist of a rule header (left side) and a rule body (right side). Thus, the first rule in the example given above means in translation: If ?Y is a man, whose father is ?X, then ?Y is one of the sons of ?X (there might be more than one).

Finally, we formulate a query, inquiring for all women having a son whose father is Abraham. In other words: With which women did Abraham have a son?
?- ?X:woman[sonIs->?Y[fatherIs->abraham]].

The syntax of a query is similar to the definition of a rule, but the rule header is omitted.

The answer is:

?X = sarah
?X = hagar

### Queries and Inference

Let us consider an example of a query. A user would like to inquire about the level of knowledge of a person, known to the user, with the name “Mustermann”. For one particular categorical structure, a corresponding query could be expressed in F-Logic as follows (see below for another more exhaustive example):
?- ?X:person[name->Mustermann, knows->?Y].

A declarative rule that can be used to process this query can be worded as follows: “If a person writes a document, and the document deals with a given subject matter, then this person has knowledge of the subject matter.” Using F-Logic, this rule could be expressed in the following way (see below):

?Y[knows−>?Z] :- ?X:document[author−>?Y:person] and

?X[field−>?Z].

The categories “persons” and “document” from two different categorical structures are linked in this way. Reference is made to the subject of the document, wherein the subject of the document is allocated as data to the attribute “subject” of the category “document”.

The areas of knowledge of the person with the name “Mustermann” are obtained as output variables for the above given query.

For implementing this example, several logic languages can be used. As an example, an implementation using the preferred logic language “F-Logic” will be demonstrated.

/* ontology */
author::person.
field::science.
biotechnology:field.
physics:field.
chemistry:field.
document[author{1:*}*=>author; field{1:*}*=>field].
person[authorOf{0:*}*=>document].

In this first section, the ontology itself is defined: The data contain documents with two relevant attributes—the author and the scientific field.

/* facts */
Paul: person.
Anna: person.
Mustermann: person.
doc1: document[field−>biotechnology, author−>Paul].
doc2: document[field−>biotechnology, author−>Paul].
doc3: document[field−>chemistry, author−>Paul].
doc100: document[field−>physics, author−>Anna].
doc101: document[field−>physics, author−>Anna].
doc200: document[field−>biotechnology,

author−>Mustermann].

doc201: document[field−>biotechnology,

author−>Mustermann].

doc202: document[field−>biotechnology,

author−>Mustermann].

In this section, we defined the facts of the ontology. There are eight documents (named doc1, . . . , doc202) with the given fields of technology and the given authors.

/* query */
?- Mustermann[knows−>?X:field].

This section is the actual query section. Using the declarative rules defined in the previous section, we deduce, by inference, the fields of experience of the author “Mustermann”.

In the inference unit, the above query is evaluated using the above rule. This is shown as a forward chaining process meaning that the rules are applied to the data and derived data as long as new data can be deduced.

Given the above facts about the documents and the above given rule:

?Y[knows−>?Z] :- ?X:document[author−>?Y:person] and

?X[field−>?Z].

first all substitutions of the variables ?X, ?Y and ?Z are computed which make the rule body true:

?X=doc1, ?Y=Paul, ?Z=biotechnology
?X=doc2, ?Y=Paul, ?Z=biotechnology
?X=doc3, ?Y=Paul, ?Z=chemistry
?X=doc100, ?Y=Anna, ?Z=physics
?X=doc101, ?Y=Anna, ?Z=physics
?X=doc200, ?Y=Mustermann, ?Z=biotechnology
?X=doc201, ?Y=Mustermann, ?Z=biotechnology
?X=doc202, ?Y=Mustermann, ?Z=biotechnology

After that the variables in the rule head are substituted by these values resulting in the following set of facts:

Paul[knows−>biotechnology].
Paul[knows−>chemistry].
Anna[knows−>physics].
Mustermann[knows−>biotechnology].

In the next step for our query
?- Mustermann[knows->?X:field].
   the variable substitutions for ?X are computed which make the query true:
?X=biotechnology

This variable substitution represents the result of our query. The result is preferably output via the input/output unit.

The example shows that the query not only obtains information stored in the database system explicitly. Rather, declarative rules of this type establish relations between elements in database systems, such that new facts can be derived, if necessary.

Thus, additional information, which cannot explicitly be found in the original database, is “created” (deduced) by inference: In the original database (which, in this simple example, has been “simulated” by creating the ontology in F-Logic, see above), there is no such information as “knowledge” associated (e.g. as an attribute) to a certain person. This additional information is created by inference from the authorship of the respective person, using known declarative rules.

Processing a query with the term “biotechnology” in a traditional database system would require that the user already has detailed information concerning the knowledge of Mustermann. Furthermore, the term “biotechnology” would have to be found explicitly in a data record allocated to the person Mustermann.

Processing a query with the term “knowledge” in principle would not make sense for a traditional database system because the abstract term “knowledge” cannot be allocated to a concrete fact “biotechnology”.

The example shows that, compared to traditional database systems, considerably less pre-knowledge, and thus also less information, is required for a computer system to arrive at precise search results.

It is, therefore, in some embodiments, an object of the present solution to provide a method and a system for increasing the efficiency of queries directed to a knowledge base, in particular an ontology.

This aim is achieved by embodiments of the present solution as claimed in the independent claim. Advantageous embodiments are described in the dependent claims. Even if no multiple back-referenced claims are drawn, all reasonable combinations of the features in the claims shall be disclosed.

An object of embodiments of the present solution may be achieved by a method. In what follows, individual steps of a method will be described in more detail. The steps do not necessarily have to be performed in the order given in the text. Also, further steps not explicitly stated may be part of the method.

In some aspects, the present invention is directed to a method for answering a query directed to a knowledge base comprising a declarative system of rules. The method includes the steps of:
a) creating, for each object of the knowledge base, a generic representative representing the structure of the object, the generic representative defining a generic object;
b) creating, for each rule of the knowledge base, a generic rule representing the structure of the rule;
c) creating a generic query representing the structure of the query directed to the knowledge base;
d) inferring zero or more generic answers to the generic query by evaluating the generic query and the generic rules against the generic representatives, wherein
   d1) each generic representative bound to a variable of a generic rule for inferring the zero or more generic answers is assigned to the generic rule, and wherein
   d2) each generic representative bound to a variable of the generic query for inferring the zero or more generic answers is assigned to the generic query; and
e) inferring zero or more answers to the query by evaluating the query and the rules of the knowledge base against the objects of the knowledge base, wherein
   e1) the objects bound to a variable of a rule of the knowledge base for inferring the zero or more answers to the query are restricted to objects whose structure is represented by a generic representative in the zero or more generic answers, and wherein
   e2) the objects bound to a variable of the query for inferring the zero or more answers are restricted to objects whose structure is represented by a generic representative in the zero or more generic answers.

Note that the term object is used herein to refer to data or instances, e.g. of an ontology, or generally data entries in a knowledge base, that represent certain facts from the knowledge domain to be structured by the knowledge base. Objects generally have attributes and relations to other objects.

In general, the structures of objects stored in a knowledge base follow certain patterns. They are represented by the generic representatives mentioned above. The set of these generic representatives forms the structure index of the knowledge base. The structure index proposed by the present invention makes use of these patterns to partition the objects of the knowledge base and direct generic rules to these partitions.

The basic idea underlying the present solution is to define a generic knowledge base with generic representatives and generic rules. This enables generic rules, which represent the structure of the rules of the knowledge base, to be applied to the generic representatives in a first step without evaluating the corresponding objects. In a second step, the inferred generic answers (which are generic representatives) can be used to restrict the original query to objects which have an appropriate structure. In a similar way, the inferred generic answers can be used to restrict the rules of the ontology to objects which have an appropriate structure.

Although an additional inference step is executed to answer the generic query, the overall time for answering the original query is generally reduced for two reasons. First, the number of generic representatives is expected to be significantly smaller than the number of objects of the knowledge base. Second, the number of objects with an appropriate structure, which are used to restrict the original query and the rules of the knowledge base, is likewise smaller than the overall number of objects of the knowledge base.

It should be noted that the step of creating a generic representative for each object of the knowledge base can be executed after each change to an object of the knowledge base, e.g., off-line and not in run-time. The same applies to the generation of the generic rules. This further accelerates the evaluation of queries.

The method also lends itself to parallelization in the following way:
step e) of inferring zero or more answers to the query directed to the knowledge base is executed on at least two processors;
the generic answers inferred in step d) are subdivided into disjoint subsets, wherein the number of subsets corresponds to the number of processors; and
then at least two processors are each assigned a disjoint subset of the knowledge base, wherein each subset of the knowledge base consists of objects whose structure is represented by generic representatives from one of the disjoint subsets of the generic answers.

Furthermore, an object of embodiments of the present solution is achieved by:
a computer system employing the described method.
a computer program comprising program means for performing the described method while the computer program is being executed on a computer or on a computer network.
a volatile or non-volatile machine readable storage medium having embodied thereupon instructions which, when executed by one or more processors, cause the one or more processors to perform the described method.

### BRIEF DESCRIPTION OF THE SEVERAL VIEWS OF THE DRAWINGS

Other objects and advantages of the present invention may be ascertained from a reading of the specification and appended claims in conjunction with the drawings therein.

For a more complete understanding of the present invention, reference is established to the following description made in connection with accompanying drawings in which:

FIG. 1 shows a diagram with steps of the method according to embodiments of the present invention;

FIG. 2 compares the evaluation times of an embodiment of the present invention with the evaluation times of the prior art;

FIG. 3 illustrates an embodiment in which a first one or more computing devices, sometimes referred to as clients, communicate with a second one or more computing devices, sometimes referred to as servers, to practice embodiments of the present invention; and

FIGS. 4A-4C are block diagrams of embodiments of a computing device.

### DETAILED DESCRIPTION OF THE INVENTION

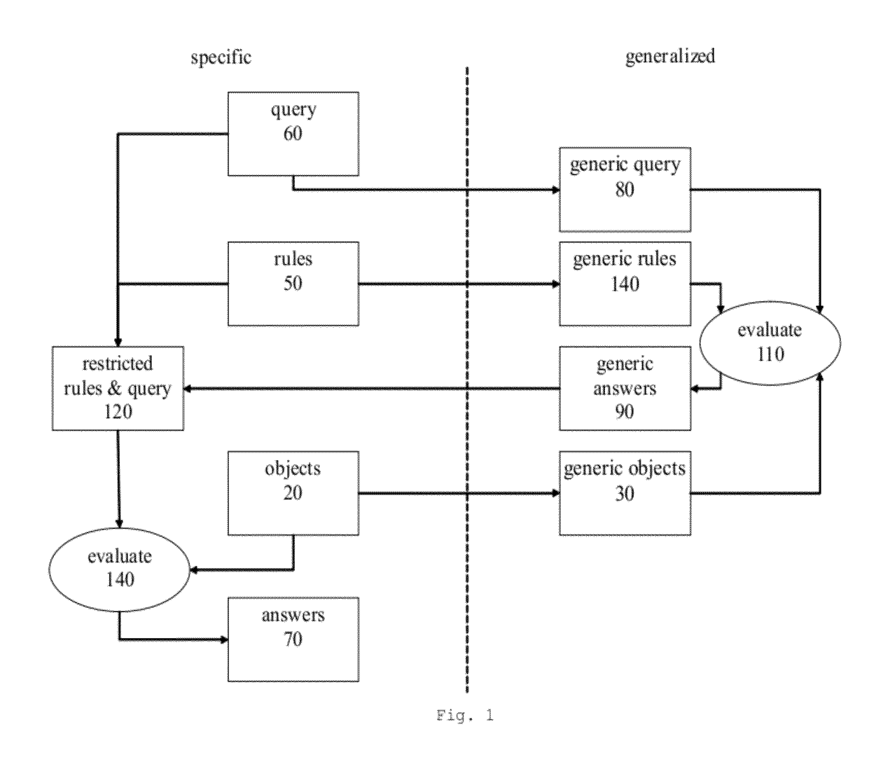

Let us consider the following example in conjunction with FIG. 1, which shows the general structure of the method, not restricted to the given example.

A simple knowledge base contains information about persons 20, e.g. last name, first name and birth date. In F-Logic three specific examples look like this:

p1[name−>“mueller”, born−>“1.7.1975”].
p2[name−>“baier”, firstname−>“juergen”, born−>“4.12.1959”].
p3[name−>“wenke”, firstname−>“dirk”, born−>“24.12.1973”].

In this case, p2 and p3 have a different structure than p1, since p1 does not contain information about the person's first name. Accordingly, p1 can be classified in a class c1, while p2 and p3 can be classified as elements of a different class c2.

For each class, a generic representative 30 is created, containing generalized values or place-holders instead of meaningful data:

r1[name−>v1, born−>v2].
r2[name−>v3, firstname−>v4, born−>v5].

All members of the respective classes have the same structure as their generic representatives 30. These generic representatives are stored in a separate module, the structure index, together with the assignment information that assigns all the elements to their generic representatives. This can be done in a predicate partition, which would look like this:

partition(r1,p1).
partition(r2,p2).
partition(r2,p3).

A useful rule 50 for a knowledge base such as this one states that the age of a person is calculated by the difference of today's date and the date of birth of the person:
?X[age->?Y]: -?X[born->?B] and ?Y is_today- ?B.

A simple query 60 to this knowledge base could be e.g. for the first and last name of all persons who are less than 38 years old. The obvious result 70 for this example is p3, i.e. “dirk” and “wenke”. (Juergen Baier is too old and Mueller has no first name.)

In F-Logic the query 60 is given by:
?- ?X[name->?Y, firstname->?Z, age->?U] and ?U<38.

When using the structure index, the query 60 initiates a two step procedure. First, a generic query 80 is used to find appropriate representatives 90.

Since the structure patterns (and thus the generic representatives) do not contain meaningful data, queries are generalized by removing all conditions which refer to specific data values. Any remaining constants are replaced by variables, and “built-ins” are removed. In this case, we only have the condition “?U<38”, which is removed when creating the generic query 80:
?- ?X[name->?Y, firstname->?Z, age->?U]@SI.

Further generalization steps are not required for this query. In some embodiments, generic queries 80 are posed to the structure index module only, which is indicated by “@SI” in the generic query.

Furthermore, the rules 50 are generalized. In some embodiments, the rules 50 must be generalized. This can be accomplished in the same way as the generalization of the queries. Thus, rules are generalized by removing all conditions which refer to specific data values, and/or by replacing any remaining constants in the rule body with variables, and/or by removing “built-ins”. In the above given rule for calculating the age of a person, we have “_today” as specific data value, which is to be removed when creating the generic rule 140. Thus we have as generic rule in this example:
?X[age->v6]@SI: -?X[born->?B]@SI.

Note that the variable “?Y” in the rule head has been replaced by a constant “v6”, since the variable no longer occurs in the rule body after the generalization step, and therefore is no longer to be found in the rule head either. In some embodiments, both sides of the generic rule 140 are posed to the structure index module only, which is indicated by “@SI” in the generic rule on both sides.

In the next step 110, the generic query is evaluated. To this end, in some embodiments, the query 80 is posed to the structure index module only, indicated by “@SI”. Furthermore, the rule for the age given above has been used. The result is thus:
?X=r2, ?Y=v3, ?Z=v4, ?U=v6

It becomes clear that the answer 90 to the generic query 80 is r2, the generic representative of class c2.

In the second step, a modified version 120 of the original query 60 is created, restricting the query to those elements that are represented by the generic representatives 90 obtained in the first step. In this case, that is all the elements of class c2.

?- partition(r2,?X) and

?X[name−>?Y, firstname−>?Z, age−>?U] and ?U < 38.

The partition statement is true for those elements that are represented by the generic representative r2 and false for all others. In a similar way, the rule 50 is restricted:

?X[age−>?Y] :- partition(r2,?X) and ?X[born−>?B] and ?Y is

_today − ?B.

It is a coincidence that the restrictions for the query and the rule are identical in this case. In other cases there might be differing restrictions for some rules or the query. The restrictions for the rules are determined during the evaluation of the generic query by observing which generic objects make the generic rule true for answering the given generic query.

As a result, the correct and specific answer 70 to the original query is obtained (by evaluation step 140):
?X=p3, ?Y=“wenke”, ?Z=“dirk”, ?U=37.
   Evaluation Times with and without Structure Index

Use of a structure index should strongly accelerate the inference process for the resolution of queries in knowledge bases or ontologies, despite posing two queries instead of one. The reason is that the number of different classes and thus different generic representatives should be small compared to the number of elements of the original knowledge base that they represent.

As an example, the structure index method has been applied to a larger knowledge base: the DBLP index that describes authors and their publications. The DBLP knowledge base contains 215127 objects. The classification process created 477 different classes. Thus the structure index contains 477 generic representatives with their attributes and relations.

The following query is intended to retrieve all authors, who published a publication in a journal, the publication should have an ee value and a number, it should be available online and on CDROM. It also asks for the publication date.

?- ?A[journal−>?Y, ee−>?M, url−>?U, number−>?N, mdate−>?D,
cdrom−>?C].

This query cannot be generalized any further and is thus directly used to retrieve the generic representatives from the structure index:

?- ?A[journal−>?Y,ee−>?M,url−>?U,number−>?N,mdate−>?D, cdrom−
>?C]@SI.

This query yields 118 (out of 477) generic representatives as answers. These 118 answers are representatives for 5146 objects. This query requires 31 ms evaluation time in order to identify 5146 possibly relevant objects out of a total of 215127 objects.

The original query is then restricted to these 5146 objects:

?- representatives(?R) and partition(?R,?A)@SI and
?A[journal−>?Y, ee−>?M, url−>?U, number−>?N, mdate−>?D,
cdrom−>?C].

This second step delivers the correct 4424 results in 218 ms.

The original query, directly posed to the whole knowledge base instead of using the structure index, also returns 4424 answers, but in 4015 ms. Thus the structure index approach is much faster.

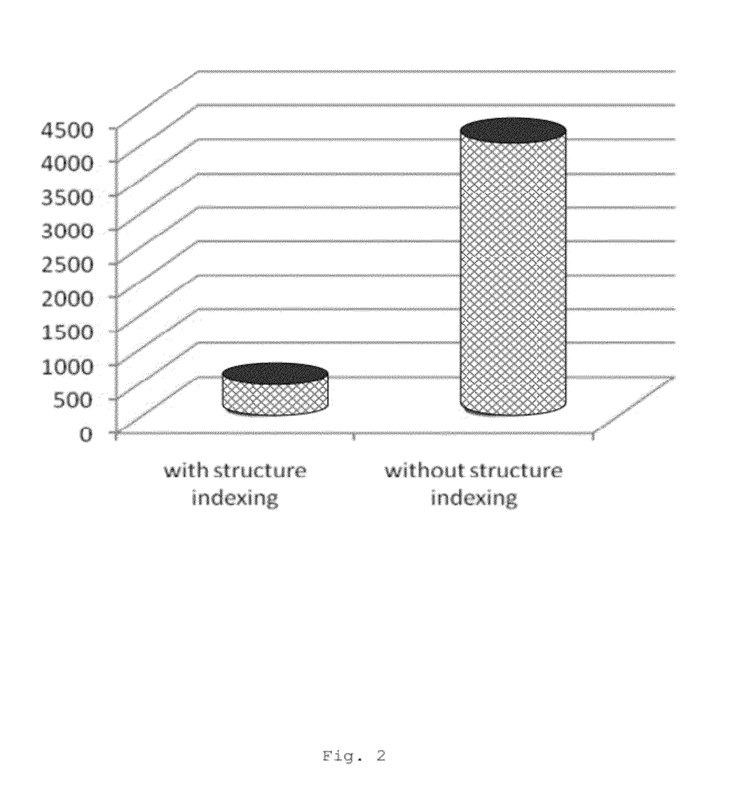

This can be seen in FIG. 2, which depicts the time in ms taken in the above example with or without the structure index.

### Partitioning of Knowledge Bases and Distributed Reasoning

The same principle may also be used to distribute the reasoning process itself on different computers. If the set of representatives has been determined by the first query this set could be split up into 2 (or more generally into n) subsets. The second query can now be evaluated separately for the different subsets, either on multiple computers or multiple processors. For this purpose, each of these subsets is sent to a different processor or computer, which computes the second query for its own set of representatives. Thus the main effort, the computation of the final result set, is distributed to different processors or computers.

### Network and Computing Environment

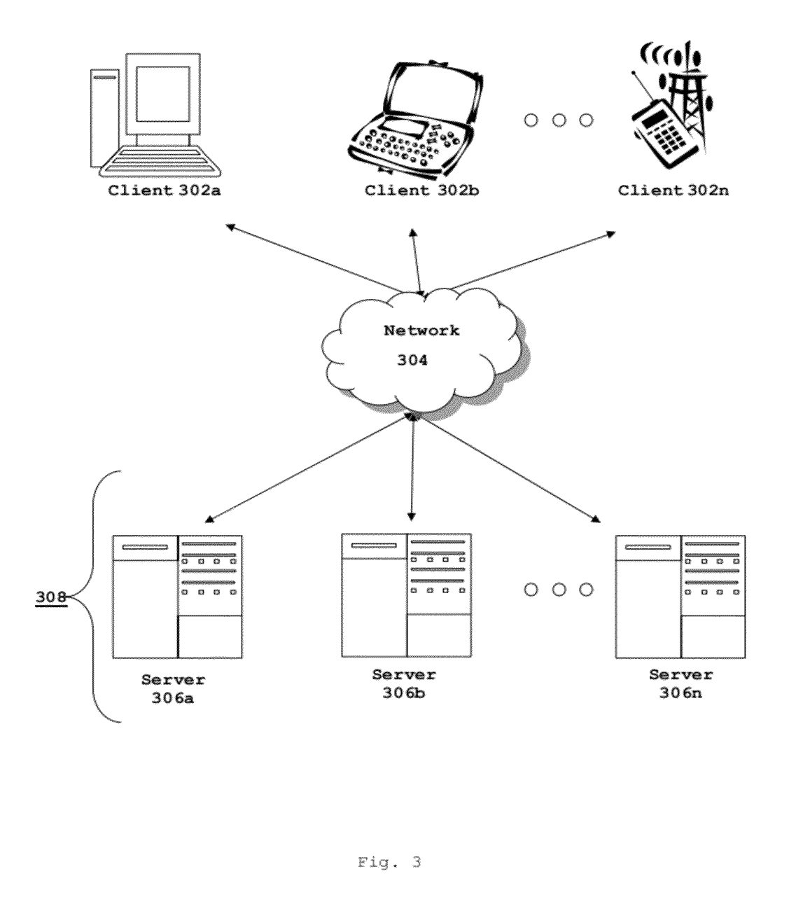

It may be helpful to briefly discuss embodiments of computing devices used for practicing embodiments of the systems and methods discussed above. FIG. 3 illustrates one embodiment of a computing environment that includes a first one or more computing devices 302A-302N (generally referred to herein as “client machine(s) 302”) in communication with a second one or more computing devices 306A-306N (generally referred to herein as “server(s) 306”), which may comprise a group of distributed computing devices such as a server farm 308. Installed in between the client machine(s) 302 and server(s) 306 is a network 304.

In one embodiment, the computing environment can include an appliance installed between the server(s) 306 and client machine(s) 302. This appliance can manage client/server connections, and in some cases can load balance client connections amongst a plurality of backend servers.

The client machine(s) 302 can in some embodiment be referred to as a single client machine 302 or a single group of client machines 302, while server(s) 306 may be referred to as a single server 306 or a single group of servers 306. In one embodiment a single client machine 302 communicates with more than one server 306, while in another embodiment a single server 306 communicates with more than one client machine 302. In yet another embodiment, a single client machine 302 communicates with a single server 306.

A client machine 302 can, in some embodiments, be referenced by any one of the following terms: client machine(s) 302; client(s); client computer(s); client device(s); client computing device(s); local machine; remote machine; client node(s); endpoint(s); endpoint node(s); or a second machine. The server 306, in some embodiments, may be referenced by any one of the following terms: server(s), local machine; remote machine; server farm(s), host computing device(s), or a first machine(s).

In some embodiments, any of client machines 302 or server machines 306 may comprise physical machines, virtual machines, or a combination of physical and virtual machines, and may execute via a hypervisor. A virtual machine may include any virtual machine managed by a hypervisor developed by XenSolutions, Citrix Systems, IBM, VMware, or any other hypervisor. In other embodiments, the virtual machine can be managed by any hypervisor, while in still other embodiments, the virtual machine can be managed by a hypervisor executing on a server 306 or a hypervisor executing on a client 302.

The client machines 302 or server machines 306 can in some embodiments execute, operate or otherwise provide an application that can be any one of the following: software; a program; executable instructions; a virtual machine; a hypervisor; a web browser or web server; a web-based client or server; a client-server application; a thin-client computing client or server; an ActiveX control; a Java applet; software related to voice over internet protocol (VoIP) communications like a soft IP telephone; an application for streaming video and/or audio; an application for facilitating real-time-data communications; a HTTP client or server; a FTP client or server; an Oscar client or server; a Telnet client or server; or any other set of executable instructions.

The computing environment can include more than one server 306A-306N such that the servers 306A-306N are logically grouped together into a server farm 308. The server farm 308 can include servers 306 that are geographically dispersed and logically grouped together in a server farm 306, or servers 306 that are located proximate to each other and logically grouped together in a server farm 306. Geographically dispersed servers 306A-306N within a server farm 308 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 308 may be administered as a single entity, while in other embodiments the server farm 308 can include multiple server farms 308.

In some embodiments, a server farm 308 can include servers 306 that execute a substantially similar type of operating system platform (e.g., any version of the WINDOWS operating system, manufactured by Microsoft Corp. of Redmond, Wash., UNIX, LINUX, or the Mac OS operating system, manufactured by Apple, Inc. of Cupertino, Calif.). In other embodiments, the server farm 308 can include a first group of servers 306 that execute a first type of operating system platform, and a second group of servers 306 that execute a second type of operating system platform. The server farm 308, in other embodiments, can include servers 306 that execute different types of operating system platforms.

In some embodiments, a server 306 may comprise one or more of: a file server; an application server; a web server; a proxy server; an appliance; a network appliance; a gateway; an application gateway; a gateway server; a virtualization server; a deployment server; a SSL VPN server; a firewall; a web server; an application server or as a master application server; a server 306 executing an active directory; or a server 306 executing an application acceleration program that provides firewall functionality, application functionality, or load balancing functionality. In some embodiments, a server 306 may be a RADIUS server that includes a remote authentication dial-in user service. Some embodiments include a first server 306A that receives requests from a client machine 302, forwards the request to a second server 306B, and responds to the request generated by the client machine 302 with a response from the second server 306B. The first server 306A can acquire an enumeration of applications available to the client machine 302 and well as address information associated with an application server 306 hosting an application identified within the enumeration of applications. The first server 306A can then present a response to the client's request using a web interface, and communicate directly with the client 302 to provide the client 302 with access to an identified application.

Client machines 302 can, in some embodiments, be a client node that seeks access to resources provided by a server 306. In other embodiments, the server 306 may provide clients 302 or client nodes with access to hosted resources. The server 306, in some embodiments, functions as a master node such that it communicates with one or more clients 302 or servers 306. In some embodiments, the master node can identify and provide address information associated with a server 306 hosting a requested application, to one or more clients 302 or servers 306. In still other embodiments, the master node can be a server farm 308, a client 302, a cluster of client nodes 302, or an appliance.

One or more clients 302 and/or one or more servers 306 can transmit data over a network 304 installed between machines and appliances within the computing environment. The network 304 can comprise one or more sub-networks, and can be installed between any combination of the clients 302, servers 306, computing machines and appliances included within the computing environment. In some embodiments, the network 304 can be: a local-area network (LAN); a metropolitan area network (MAN); a wide area network (WAN); a primary network 304 comprised of multiple sub-networks 304 located between the client machines 302 and the servers 306; a primary public network 304 with a private sub-network 304; a primary private network 304 with a public sub-network 304; or a primary private network 304 with a private sub-network 304. Still further embodiments include a network 304 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; a wireless network; a wireline network; or a network 304 that includes a wireless link where the wireless link can be an infrared channel or satellite band. The network topology of the network 304 can differ within different embodiments, possible network topologies include: a bus network topology; a star network topology; a ring network topology; a repeater-based network topology; or a tiered-star network topology. Additional embodiments may include a network 304 of mobile telephone networks that use a protocol to communicate among mobile devices, where the protocol can be any one of the following: AMPS; TDMA; CDMA; GSM; GPRS UMTS; or any other protocol able to transmit data among mobile devices.

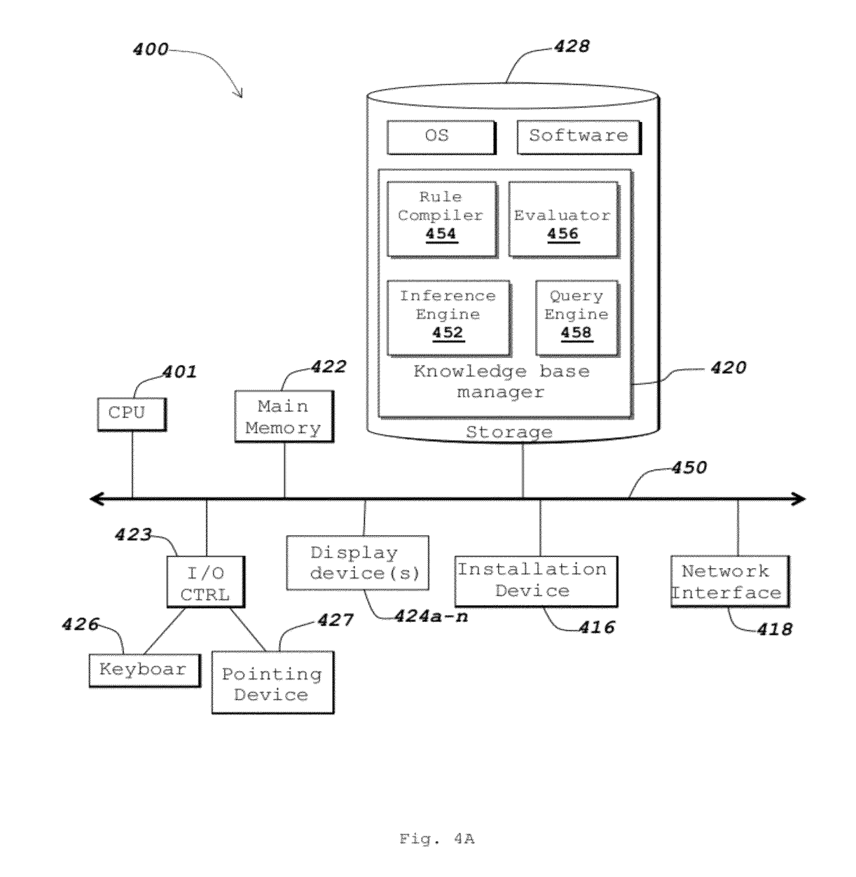

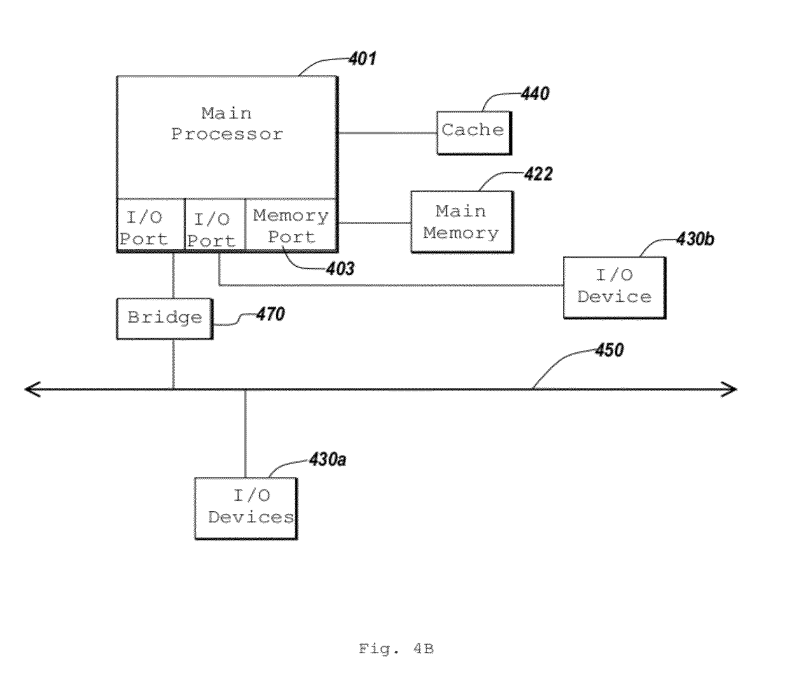

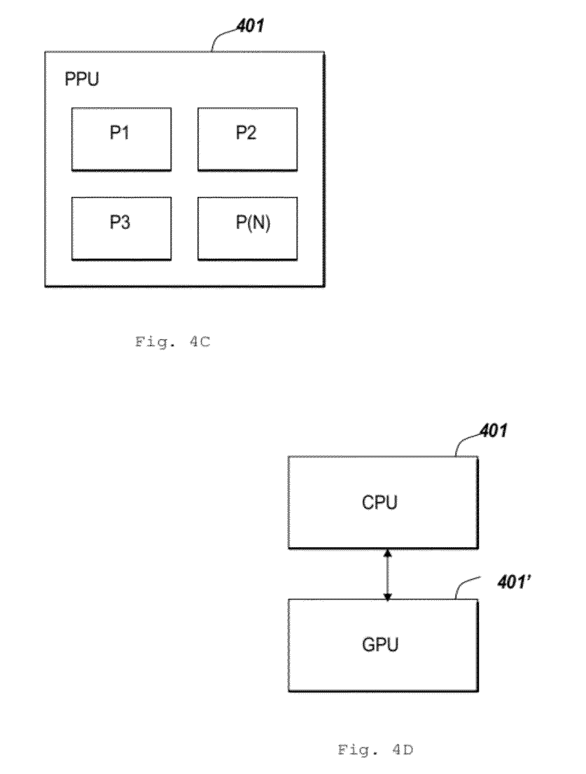

The client 302, server 306, or any appliances deployed as intermediaries or endpoints in the computing environment may be deployed as and/or executed on any type and form of computing device, such as a computer, network device or appliance capable of communicating on any type and form of network and performing the operations described herein. FIGS. 4A and 4B depict block diagrams of a computing device 400 useful for practicing an embodiment of the client 302, server 306 or appliance. As shown in FIGS. 4A and 4B, each computing device 400 includes a central processing unit 401, and a main memory unit 422. As shown in FIG. 4A, a computing device 400 may include a visual display device 424, a keyboard 426 and/or a pointing device 427, such as a mouse. Each computing device 400 may also include additional optional elements, such as one or more input/output devices 430a-430n (generally referred to using reference numeral 430) as shown in FIG. 4B, and a cache memory 440 in communication with the central processing unit 401.

The central processing unit 401 is any logic circuitry that responds to and processes instructions fetched from the main memory unit 422. In many embodiments, the central processing unit is provided by a microprocessor unit, such as: those manufactured by Intel Corporation of Mountain View, Calif.; those manufactured by Motorola Corporation of Schaumburg, Ill.; those manufactured by Transmeta Corporation of Santa Clara, Calif.; the RS/6000 processor, those manufactured by International Business Machines of White Plains, N.Y.; or those manufactured by Advanced Micro Devices of Sunnyvale, Calif. The computing device 400 may be based on any of these processors, or any other processor capable of operating as described herein.

Main memory unit 422 may be one or more memory chips capable of storing data and allowing any storage location to be directly accessed by the microprocessor 401, such as Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDEC SRAM, PC100 SDRAM, Double Data Rate SDRAM (DDR SDRAM), Enhanced SDRAM (ESDRAM), SyncLink DRAM (SLDRAM), Direct Rambus DRAM (DRDRAM), or Ferroelectric RAM (FRAM). The main memory 422 may be based on any of the above described memory chips, or any other available memory chips capable of operating as described herein. In the embodiment shown in FIG. 4A, the processor 401 communicates with main memory 422 via a system bus 450 (described in more detail below). FIG. 4B depicts an embodiment of a computing device 400 in which the processor communicates directly with main memory 422 via a memory port 403. For example, in FIG. 4B the main memory 422 may be DRDRAM.

FIG. 4B depicts an embodiment in which the main processor 401 communicates directly with cache memory 440 via a secondary bus, sometimes referred to as a backside bus. In other embodiments, the main processor 401 communicates with cache memory 440 using the system bus 450. Cache memory 440 typically has a faster response time than main memory 422 and is typically provided by SRAM, BSRAM, or EDRAM. In the embodiment shown in FIG. 4B, the processor 401 communicates with various I/O devices 430 via a local system bus 450. Various busses may be used to connect the central processing unit 401 to any of the I/O devices 430, including a VESA VL bus, an ISA bus, an EISA bus, a MicroChannel Architecture (MCA) bus, a PCI bus, a PCI-X bus, a PCI-Express bus, or a NuBus. For embodiments in which the I/O device is a video display 424, the processor 401 may use an Advanced Graphics Port (AGP) to communicate with the display 424. FIG. 4B depicts an embodiment of a computer 400 in which the main processor 401 communicates directly with I/O device 430b via HyperTransport, Rapid I/O, or InfiniBand. FIG. 1F also depicts an embodiment in which local busses and direct communication are mixed: the processor 401 communicates with I/O device 430a using a local interconnect bus while communicating with I/O device 430b directly.

The computing device 400 may support any suitable installation device 416, such as a floppy disk drive for receiving floppy disks such as 3.5-inch, 5.25-inch disks or ZIP disks, a CD-ROM drive, a CD-R/RW drive, a DVD-ROM drive, tape drives of various formats, USB device, hard-drive or any other device suitable for installing software and programs such as a knowledge base manager 420, or portion thereof, discussed in more detail below. The computing device 400 may further comprise a storage device 428, such as one or more hard disk drives or redundant arrays of independent disks, for storing an operating system and other related software, and for storing application software programs such as any program related to the knowledge base manager 420. Optionally, any of the installation devices 416 could also be used as the storage device 428. Additionally, the operating system and the software can be run from a bootable medium, for example, a bootable CD, such as KNOPPIX®, a bootable CD for GNU/Linux that is available as a GNU/Linux distribution from knoppix.net.

Furthermore, the computing device 400 may include a network interface 418 to interface to a Local Area Network (LAN), Wide Area Network (WAN) or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. The network interface 418 may comprise a built-in network adapter, network interface card, PCMCIA network card, card bus network adapter, wireless network adapter, USB network adapter, modem or any other device suitable for interfacing the computing device 400 to any type of network capable of communication and performing the operations described herein. A wide variety of I/O devices 430a-430n may be present in the computing device 400. Input devices include keyboards, mice, trackpads, trackballs, microphones, and drawing tablets. Output devices include video displays, speakers, inkjet printers, laser printers, and dye-sublimation printers. The I/O devices 430 may be controlled by an I/O controller 423 as shown in FIG. 4A. The I/O controller may control one or more I/O devices such as a keyboard 426 and a pointing device 427, e.g., a mouse or optical pen. Furthermore, an I/O device may also provide storage 428 and/or an installation medium 416 for the computing device 400. In still other embodiments, the computing device 400 may provide USB connections to receive handheld USB storage devices such as the USB Flash Drive line of devices manufactured by Twintech Industry, Inc. of Los Alamitos, Calif.

In some embodiments, the computing device 400 may comprise or be connected to multiple display devices 424a-424n, which each may be of the same or different type and/or form. As such, any of the I/O devices 430a-430n and/or the I/O controller 423 may comprise any type and/or form of suitable hardware, software, or combination of hardware and software to support, enable or provide for the connection and use of multiple display devices 424a-424n by the computing device 400. For example, the computing device 400 may include any type and/or form of video adapter, video card, driver, and/or library to interface, communicate, connect or otherwise use the display devices 424a-424n. In one embodiment, a video adapter may comprise multiple connectors to interface to multiple display devices 424a-424n. In other embodiments, the computing device 400 may include multiple video adapters, with each video adapter connected to one or more of the display devices 424a-424n. In some embodiments, any portion of the operating system of the computing device 400 may be configured for using multiple displays 424a-424n. In other embodiments, one or more of the display devices 424a-424n may be provided by one or more other computing devices, such as computing devices 400a and 400b connected to the computing device 400, for example, via a network. These embodiments may include any type of software designed and constructed to use another computer's display device as a second display device 424a for the computing device 400. One ordinarily skilled in the art will recognize and appreciate the various ways and embodiments that a computing device 400 may be configured to have multiple display devices 424a-424n.

In further embodiments, an I/O device 430 may be a bridge 470 between the system bus 450 and an external communication bus, such as a USB bus, an RS-232 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, a Thunderbolt bus, a Serial Attached small computer system interface bus, or any other type and form of communication bus.

A computing device 400 of the sort depicted in FIGS. 4A and 4B typically operate under the control of operating systems, which control scheduling of tasks and access to system resources. The computing device 400 can be running any operating system such as any of the versions of the Microsoft®Windows operating systems, the different releases of the Unix and Linux operating systems, any version of the Mac OS® for Macintosh computers, any embedded operating system, any realtime operating system, any open source operating system, any proprietary operating system, any operating systems for mobile computing devices, or any other operating system capable of running on the computing device and performing the operations described herein. Typical operating systems include: WINDOWS 3.x, WINDOWS 95, WINDOWS 98, WINDOWS 2000, WINDOWS NT 3.51, WINDOWS NT 4.0, WINDOWS CE, WINDOWS XP, WINDOWS VISTA, WINDOWS 7, and WINDOWS 8, all of which are manufactured by Microsoft Corporation of Redmond, Wash.; MacOS, including the OSX variants, manufactured by Apple Computer of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others.

In other embodiments, the computing device 400 may have different processors, operating systems, and input devices consistent with the device. For example, in one embodiment the computer 400 is an iPhone smart phone or iPad tablet manufactured by Apple, Inc. In this embodiment, the Apple smart phone is operated under the control of the iOS operating system and includes a multitouch screen input device. Moreover, the computing device 400 can be any workstation, desktop computer, laptop or notebook computer, server, handheld computer, mobile telephone, any other computer, or other form of computing or telecommunications device that is capable of communication and that has sufficient processor power and memory capacity to perform the operations described herein.

As shown in FIG. 4C, the computing device 400 may comprise multiple processors and may provide functionality for simultaneous execution of instructions or for simultaneous execution of one instruction on more than one piece of data. In some embodiments, the computing device 400 may comprise a parallel processor with one or more cores. In one of these embodiments, the computing device 400 is a shared memory parallel device, with multiple processors and/or multiple processor cores, accessing all available memory as a single global address space. In another of these embodiments, the computing device 400 is a distributed memory parallel device with multiple processors each accessing local memory only. In still another of these embodiments, the computing device 400 has both some memory which is shared and some memory which can only be accessed by particular processors or subsets of processors. In still even another of these embodiments, the computing device 400, such as a multi-core microprocessor, combines two or more independent processors into a single package, often a single integrated circuit (IC). In yet another of these embodiments, the computing device 400 includes a chip having a CELL BROADBAND ENGINE architecture and including a Power processor element and a plurality of synergistic processing elements, the Power processor element and the plurality of synergistic processing elements linked together by an internal high speed bus, which may be referred to as an element interconnect bus.

In some embodiments, the processors provide functionality for execution of a single instruction simultaneously on multiple pieces of data (SIMD). In other embodiments, the processors provide functionality for execution of multiple instructions simultaneously on multiple pieces of data (MIMD). In still other embodiments, the processor may use any combination of SIMD and MIMD cores in a single device.

In some embodiments, the computing device 400 may comprise a graphics processing unit. In one of these embodiments, depicted in FIG. 4D, the computing device 400 includes at least one central processing unit 401 and at least one graphics processing unit. In another of these embodiments, the computing device 400 includes at least one parallel processing unit and at least one graphics processing unit. In still another of these embodiments, the computing device 400 includes a plurality of processing units of any type, one of the plurality of processing units comprising a graphics processing unit.

In some embodiments, a first computing device 400a executes an application on behalf of a user of a client computing device 400b. In other embodiments, a computing device 400a executes a virtual machine, which provides an execution session within which applications execute on behalf of a user or a client computing devices 400b. In one of these embodiments, the execution session is a hosted desktop session. In another of these embodiments, the computing device 400 executes a terminal services session. The terminal services session may provide a hosted desktop environment. In still another of these embodiments, the execution session provides access to a computing environment, which may comprise one or more of: an application, a plurality of applications, a desktop application, and a desktop session in which one or more applications may execute.

Referring back to FIG. 4A and in more detail, in some embodiments, a computing device 400 such as a client 302, server 306, or any combination of clients, servers, or other computing devices acting as a distributed computing environment may execute a knowledge base manager 420. Knowledge base manager 420 may comprise an application, server, service, routine, daemon, or other executable code for answering a query directed to a knowledge base, such as a database or an ontology. Knowledge base manager 420 may comprise one or more of: an inference unit or inference engine 352, a rule engine or rule compiler 454, a program evaluator 456, and a query unit or query engine 458. In some embodiments, knowledge base manager 420 may also comprise an input/output unit, which may comprise an interface or API for receiving queries and transmitting responses to other applications or services, I/O devices, or other computing devices via a network.

In some embodiments, an inference engine 352 may comprise an application, service, routine, module, or other executable code for answering queries by logical conclusion or through finding new information hidden in related data. An inference engine 352 may evaluate rules and logic expressions to resolve queries, as discussed above. In one embodiment, the inference engine 352 performs a mixture of forward and backward chaining to compute (the smallest possible) subset of the model for answering the query. In most cases, this is much more efficient than the simple forward or backward chaining evaluation strategy. The inference engine 352 may comprise a deductive main memory-based reasoning system. In some embodiments, the inference engine 352 may check program characteristics of a query and decide which of a number of predetermined evaluation strategies should be used for a specific query. In other embodiments, the inference engine 352 may comprise a framework for different evaluation strategies or methods. In still other embodiments, the inference engine may comprise a set of rewriters for optimization or unfolding of queries or rules. In yet still other embodiments, the inference engine may comprise a framework for different rule compilers or operator implementations. The inference engine 352 may also comprise an operator net evaluator for evaluating compiled operator nets, or sets of rules and queries compiled into interconnected elementary operations to perform the inference described by the rules. Operator nets may consist of graphs of operators, each receiving tuples of terms for processing, with the results sent into the graph. Operators may include those for: joining tuple sets (e.g. logical AND); negation (logical NOT); matching (e.g. of facts and variables); built-ins; accessing a database; or any other operators. In some embodiments, the inference engine 352 may select one or more rules needed to evaluate a query by choosing a corresponding sub-rule graph or sub-operator net. The selected rules may form a program comprising an intensional database (IDB) and extensional database (EDB).

In some embodiments, the inference engine 352 may be a multithreaded application or process, and may use a thread pool of dynamically adapted size. The size of the thread pool may depend on the number of available cores/CPUs and their workload. If an evaluator of the inference engine is notified of an operation which should be queued for evaluation, it is checked if the operation can be executed immediately in a separate thread or if it needs to be queued until some evaluation thread has been finished.

The inference engine 452 or knowledge base manager 420 may comprise or interact with a rule compiler 454. A rule compiler 454 may comprise an application, service, daemon, routine, or other executable code for compiling a set of rules and query into an operator net, as discussed above. The operator net contains the elementary operations and connects them in an appropriate manner to perform the inference described by the rules. An edge in the operator net describes the data flow, i.e. the result of an operator flowing to another operator. Although only one rule compiler 454 is illustrated, in many embodiments, multiple rule compilers 454 may be included, each optimized for a different type of analysis or reasoning, including top-down, bottom-up, magic set, selective linear definite (SLD) clause resolution, dynamic filtering reasoning, or any other type of resolution.

In some embodiments, the inference engine 452 or knowledge base manager 420 may comprise or interact with an evaluator 456. An evaluator 456 may comprise an application, service, daemon, module, or other executable code for checking program characteristics and deciding which evaluation strategy and/or rule compiler 454 should be used for a specific query. The evaluator 456 may comprise multiple program or query rewriters, capable of optimizing the query. Evaluator 456 may determine if the program or query is bottom-up evaluable, whether the program or query includes function symbols, whether the program or query includes well founded or stratified negations, or whether additional explanations need to be created. In some embodiments, evaluator 456 may also evaluate a compiled operator net, retreiving data and performing queued elementary operations of the net. In a further embodiment, evaluator 456 may generate and output answers to queries.

In some embodiments, knowledge base manager 420 or inference engine 452 may comprise or interact with a query engine 458. Query engine 458 may comprise an application, service, daemon, module, or other executable code for determining output variables by accessing stored data. Data may be allocated to predetermined classes, part of at least one stored class structure forming an ontology.

The methods and systems described herein may be provided as one or more computer-readable programs embodied on or in one or more articles of manufacture. The article of manufacture may be a floppy disk, a hard disk, a compact disc, a digital versatile disc, a flash memory card, a PROM, a RAM, a ROM, or a magnetic tape. In general, the computer-readable programs may be implemented in any programming language. Some examples of languages that can be used include C, C++, C#, or JAVA. The software programs may be stored on or in one or more articles of manufacture as object code.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While the present invention has been described and illustrated in conjunction with a number of specific embodiments, those skilled in the art will appreciate that variations and modifications may be made without departing from the principles of the invention as herein illustrated, as described and claimed. The present invention may be embodied in other specific forms without departing from their spirit or essential characteristics. The described embodiments are considered in all respects to be illustrative and not restrictive. The scope of the invention is, therefore, indicated by the appended claims, rather than by the foregoing description. All changes which come within the meaning and range of equivalence of the claims are to be embraced within their scope.

What is claimed:

1. A method for answering a query directed to a knowledge base comprising a declarative system of rules, the method comprising:
a) creating for each object of the knowledge base, by a knowledge base manager executing on a device, a generic representative representing the structure of the object, the generic representative defining a generic object;
b) creating for each rule of the knowledge base, by the knowledge base manager, a generic rule representing the structure of the rule;
c) creating, by the knowledge base manager, a generic query representing the structure of the query directed to the knowledge base;
d) inferring, by the knowledge base manager, zero or more generic answers to the generic query by evaluating the generic query and the generic rules against the generic representatives, wherein
d1) each generic representative bound to a variable of a generic rule for inferring the zero or more generic answers is assigned to the generic rule, and wherein
d2) each generic representative bound to a variable of the generic query for inferring the zero or more generic answers is assigned to the generic query; and
e) inferring, by the knowledge base manager, zero or more answers to the query by evaluating the query and the rules of the knowledge base against the objects of the knowledge base, wherein
e1) the objects bound to a variable of a rule of the knowledge base for inferring the zero or more answers to the query are restricted to objects whose structure is represented by a generic representative in the zero or more generic answers, and wherein
e2) the objects bound to a variable of the query for inferring the zero or more answers are restricted to objects whose structure is represented by a generic representative in the zero or more generic answers.

2. The method according to claim 1, wherein step a) of creating a generic representative for each object of the knowledge base is executed after each change to an object of the knowledge base.

3. The method according to claim 1, wherein the step b) of creating a generic rule for each rule of the knowledge base is executed after each change to a rule of the knowledge base.

4. The method according to claim 1, where step e) of inferring zero or more answers to the query directed to the knowledge base is executed on at least two processors;
the generic answers inferred in step d) are subdivided into disjoint subsets, wherein the number of subsets corresponds to the number of processors; and
the at least two processors are each assigned a disjoint subset of the knowledge base, wherein each subset of the knowledge base consists of objects whose structure is represented by generic representatives from one of the disjoint subsets of the generic answers.

5. A system for answering a query directed to a knowledge base comprising a declarative system of rules, the system comprising:
a knowledge base stored on a device;
a knowledge base manager executing on the device, the knowledge base manager creating, for each object of the knowledge base, a generic representative representing the structure of the object, the generic representative defining a generic object; creating, for each rule of the knowledge base, a generic rule representing the structure of the rule and creating a generic query representing the structure of the query directed to the knowledge base;
wherein the knowledge base manager infers zero or more generic answers to the generic query by evaluating the generic query and the generic rules against the generic representatives,
wherein each generic representative bound to a variable of a generic rule for inferring the zero or more generic answers is assigned to the generic rule, and
wherein each generic representative bound to a variable of the generic query for inferring the zero or more generic answers is assigned to the generic query; and
wherein the knowledge base manager infers zero or more answers to the query by evaluating the query and the rules of the knowledge base against the objects of the knowledge base,
wherein the objects bound to a variable of a rule of the knowledge base for inferring the zero or more answers to the query are restricted to objects whose structure is represented by a generic representative in the zero or more generic answers, and
wherein the objects bound to a variable of the query for inferring the zero or more answers are restricted to objects whose structure is represented by a generic representative in the zero or more generic answers.

6. A computer program comprising program means that, while the computer program is being executed on a computer, cause the computer to perform:
a) creating, for each object of the knowledge base, a generic representative representing the structure of the object, the generic representative defining a generic object;
b) creating, for each rule of the knowledge base, a generic rule representing the structure of the rule;
c) creating a generic query representing the structure of the query directed to the knowledge base;
d) inferring zero or more generic answers to the generic query by evaluating the generic query and the generic rules against the generic representatives, wherein
d1) each generic representative bound to a variable of a generic rule for inferring the zero or more generic answers is assigned to the generic rule, and wherein
d2) each generic representative bound to a variable of the generic query for inferring the zero or more generic answers is assigned to the generic query; and
e) inferring zero or more answers to the query by evaluating the query and the rules of the knowledge base against the objects of the knowledge base, wherein
e1) the objects bound to a variable of a rule of the knowledge base for inferring the zero or more answers to the query are restricted to objects whose structure is represented by a generic representative in the zero or more generic answers, and wherein
e2) the objects bound to a variable of the query for inferring the zero or more answers are restricted to objects whose structure is represented by a generic representative in the zero or more generic answers.

7. A volatile or non-volatile machine readable storage medium having embodied thereupon instructions which, when executed by one or more processors, cause the one or more processors to perform:
a) creating, for each object of the knowledge base, a generic representative representing the structure of the object, the generic representative defining a generic object;
b) creating, for each rule of the knowledge base, a generic rule representing the structure of the rule;
c) creating a generic query representing the structure of the query directed to the knowledge base;
d) inferring zero or more generic answers to the generic query by evaluating the generic query and the generic rules against the generic representatives, wherein
d1) each generic representative bound to a variable of a generic rule for inferring the zero or more generic answers is assigned to the generic rule, and wherein
d2) each generic representative bound to a variable of the generic query for inferring the zero or more generic answers is assigned to the generic query; and
e) inferring zero or more answers to the query by evaluating the query and the rules of the knowledge base against the objects of the knowledge base, wherein
e1) the objects bound to a variable of a rule of the knowledge base for inferring the zero or more answers to the query are restricted to objects whose structure is represented by a generic representative in the zero or more generic answers, and wherein
e2) the objects bound to a variable of the query for inferring the zero or more answers are restricted to objects whose structure is represented by a generic representative in the zero or more generic answers.
